(19) United States
(12) Patent Application Publication
(10) Pub. No.: US 2025/0015465 A1
(43) Pub. Date: Jan. 9, 2025

(54) BATTERY AND ELECTRONIC DEVICE

(71) Applicant: ZHUHAI COSMX POWER CO., LTD., Zhuhai (CN)

(72) Inventors: Zengke HUANG, Zhuhai (CN); Guotai LI, Zhuhai (CN); Qiuwan JIANG, Zhuhai (CN); Ziqiang JIANG, Zhuhai (CN)

(73) Assignee: ZHUHAI COSMX POWER CO., LTD., Zhuhai (CN)

(21) Appl. No.: 18/760,463

(22) Filed: Jul. 1, 2024

(30) Foreign Application Priority Data
Jul. 3, 2023 (CN) 202321711943.6

(51) Int. Cl. H01M 50/574

(52) U.S. Cl. CPC H01M 50/574

(57) ABSTRACT

A battery includes a battery cell, a battery protective board, and a connecting member. A second tab is connected to a first tab by sequentially passing through a second conductive portion, a connecting member, a first circuit, and a first conductive portion, to form a first connection circuit, and the first tab is connected to the second tab by sequentially passing through a first conductive portion, a second circuit, and a second conductive portion, to form a second connection circuit, and therefore, dual circuits in parallel are formed by the battery protective board and the battery cell, which not only reduces a magnitude of a current of a single circuit of a battery protective board, to enhance overcurrent capability of the battery protective board, but also reduces a dimension of a battery protective board, to increase an available dimension of a battery for accommodation, thus increasing capacity of a battery.

### CROSS-REFERENCE TO RELATED APPLICATIONS

The present application claims priority to Chinese Patent Application No. 202321711943.6, filed on Jul. 3, 2023, the content of which is hereby incorporated by reference in its entirety.

### TECHNICAL FIELD

The present application relates to the field of battery technologies, and in particular, to a battery and an electronic device.

### BACKGROUND

Due to the limitation of a material of a lithium battery itself, the lithium battery cannot be over-charged, over-discharged, overcurrent, short circuited, or charged and discharged at ultra-high temperature, and therefore, the lithium battery is typically provided with a battery protection board for monitoring and protection purposes. With the widespread adoption of fast charging technologies, requirements for overcurrent protection in a battery and a battery protective board have become increasingly stringent. To achieve a relatively high level of an overcurrent protection effect, a dimension of the battery protective board is correspondingly designed to be relatively large. However, the larger the dimension occupied by the battery protective board, the smaller the capacity of the battery, thereby impacting endurance of electronic devices.

### SUMMARY

The present application aims to enhance overcurrent capability of a battery protective board while being capable of solving problems in that capacity of a battery is too small due to a relatively large dimension of the battery protective board, thereby affecting endurance of electronic devices.

To solve the above problems, a first aspect of the present application provides a battery, including a battery cell, a battery protective board, and a connecting member. the battery cell includes a first tab and a second tab with opposite polarities; and the battery protective board is provided with a conductive portion, a first circuit, and a second circuit, the conductive portion includes a first conductive portion and a second conductive portion, the first conductive portion is connected to the first tab, and the second conductive portion is connected to the second tab; an end of the connecting member is connected to the first conductive portion, and another end of the connecting member is connected to the second conductive portion; the second tab is connected to the first tab by sequentially passing through the second conductive portion, the connecting member, the first circuit, and the first conductive portion, to form a first connection circuit; and the first tab is connected to the second tab by sequentially passing through the first conductive portion, the second circuit, and the second conductive portion, to form a second connection circuit.

Furthermore, the first conductive portion includes a first conductive sheet and a first conductive layer, the first conductive sheet is electrically connected to the first conductive layer, and the first tab is electrically connected to the first conductive layer through the first conductive sheet; and the second conductive portion includes a second conductive sheet and a second conductive layer, the second conductive sheet is electrically connected to the second conductive layer, and the second tab is electrically connected to the second conductive layer through the second conductive sheet.

Furthermore, the battery protective board is further provided with a third circuit, and the first conductive sheet is connected to the first conductive layer through the third circuit; and/or the battery protective board is further provided with a fourth circuit, and the second conductive sheet is connected to the second conductive layer through the fourth circuit.

Furthermore, the second tab is connected to the first tab by sequentially passing through the second conductive sheet, the second conductive layer, the connecting member, the first conductive layer, the first circuit, and the first conductive sheet, to form the first connection circuit; and the first tab is connected to the second tab by sequentially passing through the first conductive sheet, the second circuit, and the second conductive sheet, to form the second connection circuit.

Furthermore, the connecting member includes a first connecting end, a second connecting end, and a connecting portion, the first connecting end is connected to the second connecting end through the connecting portion, the first conductive layer is connected to the first connecting end by welding, and the second conductive layer is connected to the second connecting end by welding.

Furthermore, the battery protective board is further provided with an electronic component, the electronic component is connected to at least one of the first circuit or the second circuit, the electronic component is disposed between the first conductive layer and the second conductive layer, the electronic component is located between the battery protective board and the connecting portion, and an insulating layer is disposed between the connecting portion and the electronic component.

Furthermore, along a thickness direction of the battery protective board, at least a part of the connecting portion protrudes from a plane where the first connecting end and the second connecting end are located, and a distance between a protruding part of the connecting portion and the battery protective board is greater than a thickness by which the electronic component protrudes from a plane where the battery protective board is located.

Furthermore, the connecting portion includes a first connecting portion and a second connecting portion, a step-shaped connecting portion is formed by the first connecting portion and the second connecting portion, the electronic component is located between the battery protective board and the first connecting portion, the first conductive sheet is located between the battery protective board and the second connecting portion, and along a thickness direction of the battery protective board, a distance between the first connecting portion and the battery protective board is greater than a distance between the second connecting portion and the battery protective board.

Furthermore, the battery protective board includes a first side surface and a second side surface disposed opposite to each other along a thickness direction of the battery protective board, both the first conductive sheet and the second conductive sheet are disposed on the first side surface, and the electronic component is disposed on either of the following surfaces: the first side surface or the second side surface.

Furthermore, the connecting member, the electronic component, and the second conductive layer are all disposed on the second side surface, the second conductive sheet is disposed on the first side surface, the second conductive layer and the second conductive sheet are disposed opposite to each other, and along the thickness direction of the battery protective board, distances between the connecting portion in various positions and the battery protective board are equal.

Furthermore, the electronic component, the second conductive layer, the second conductive sheet, the first conductive layer, and the first conductive sheet are all disposed on the first side surface, the second conductive layer is connected to the second conductive sheet, the first conductive sheet is disposed between the first conductive layer and the second conductive layer, and the electronic component is disposed between the first conductive layer and the first conductive sheet.

Furthermore, the electronic component and the connecting member are disposed on the second side surface, and along the thickness direction of the battery protective board, distances between the connecting portion in various positions and the battery protective board are equal; the second conductive portion is disposed on the first side surface, the second conductive layer is connected to the second conductive sheet, and the second connecting end is bent from the second side surface to the first side surface and is electrically connected to the second conductive layer; and the first conductive portion is disposed on the first side surface, the first conductive layer is connected to the first conductive sheet, and the first connecting end is bent from the second side surface to the first side surface and is electrically connected to the first conductive layer.

Furthermore, two first notches are formed at an edge of the battery protective board; in a case that the second connecting end is bent from the second side surface to the first side surface, the second connecting end at a bend is accommodated within an first notch of the two first notches; and in a case that the first connecting end is bent from the second side surface to the first side surface, the first connecting end at a bend is accommodated within another first notch of the two first notches.

Furthermore, a U-shaped connecting member is formed by the first connecting end, the second connecting end, and the connecting portion, and the U-shaped connecting member is a flexible connecting member.

Furthermore, the battery cell further includes a top edge banding, the first tab and the second tab extend from the top edge banding, and the U-shaped connecting member extends toward a direction away from the top edge banding.

Furthermore, the battery cell further includes a top edge banding, the first tab and the second tab extend from the top edge banding, the U-shaped connecting member extends toward a direction close to the top edge banding, two second notches are formed at an edge of the battery protective board, and the connecting portion at bends are respectively accommodated within the two second notches.

Furthermore, the connecting portion is fixedly connected to the top edge banding by double-sided tape, adhesive paper, or glue.

Furthermore, the battery protective board is further provided with at least two connectors, and in a case that the at least two connectors comprise two connectors, along a width direction of the battery cell, both the two connectors are respectively disposed at both ends of the battery protective board, and the two connectors are electrically connected to the first connection circuit and the second connection circuit, respectively.

A second aspect of the present application provides an electronic device, including the battery described in any one of the first aspects.

In the battery and the electronic device provided by the present application, the second tab is connected to the first tab by sequentially passing through the second conductive portion, the connecting member, the first circuit, and the first conductive portion, to form the first connection circuit, and the first tab is connected to the second tab by sequentially passing through the first conductive portion, the second circuit, and the second conductive portion, to form the second connection circuit, and therefore, dual circuits in parallel are formed by the battery protective board and the battery cell, which may not only reduce a magnitude of a current of a single circuit of a battery protective board, to enhance overcurrent capability of the battery protective board, but also reduce a dimension of a battery protective board, to increase an available dimension of a battery for accommodation, thus increasing capacity of a battery.

### BRIEF DESCRIPTION OF THE DRAWINGS

FIG. 1a is a schematic structural diagram of a battery according to an embodiment of the present application.

FIG. 1b is a schematic diagram of a second connection circuit according to an embodiment of the present application.

FIG. 1c is a schematic diagram of a first connection circuit according to an embodiment of the present application.

FIG. 2 is a schematic structural diagram of a battery protective board and a connecting member that are connected in a first connection manner according to an embodiment of the present application.

FIG. 3 is a schematic structural diagram of a battery protective board and a connecting member that are connected in a second connection manner according to an embodiment of the present application.

FIG. 4 is a schematic structural diagram of a battery protective board and a connecting member that are connected in a third connection manner according to an embodiment of the present application.

FIG. 5 is a schematic structural diagram of a battery protective board and a connecting member that are connected in a fourth connection manner according to an embodiment of the present application.

FIG. 6 is a schematic structural diagram of the connecting member shown in FIG. 5 in a first setting manner.

FIG. 7 is a schematic structural diagram of the connecting member shown in FIG. 5 in a second setting manner.

### DETAILED DESCRIPTION OF THE EMBODIMENTS

Technical solutions of the present application will be clearly described in detail below in conjunction with the drawings. It should be noted that, in the description of the present application, orientations or positional relationships indicated by the term such as “center”, “longitudinal”, “transverse”, “length”, “width”, “thickness”, “up”, “down”, “front”, “rear”, “left”, “right”, “vertical”, “perpendicular”, “horizontal”, “top”, “bottom”, “inner”, or “outer” are orientations or positional relationships shown in the drawings, and are only for the convenience of describing the present application and simplifying the description, rather than indicating or implying that an apparatus or a component referred to must have a specific orientation, be constructed and operated in a specific orientation, and therefore cannot be understood as a limitation on the present application. Further, the term such as “first” or “second” is only used to describe purposes and cannot be understood as indicating or implying relative importance or implicitly indicating a quantity of technical features indicated. Thus, features limited to “first” or “second” may explicitly or implicitly include one or more of such features. Moreover, in the description of the present application, the term “at least one” means one or more, unless otherwise explicitly specified.

In this description of the present application, the description of the term “on the basis of the above embodiments” signifies that the specific features, structures, materials, or characteristics described in conjunction with an embodiment or example are included in at least one preferred embodiment or example of the present application. In the specification, illustrative expressions of the above terms may not necessarily denote the same embodiment or example. Furthermore, the specific features, structures, materials, or characteristics described may be combined in an appropriate manner in any one or more of the embodiments or examples.

Currently, in addition to increasing a dimension occupied by a battery protective board, a battery cell with three tabs or a shunt structure using a connecting sheet for transferring and welding a tab may also be used to enhance overcurrent capability of the battery protective board. However, using the battery cell with three tabs may increase difficulty in bending the battery protective board, while using the shunt structure using the connecting sheet for transferring and welding the tab may raise welding requirements, thereby reducing welding reliability and increasing difficulty in installing the battery protective board.

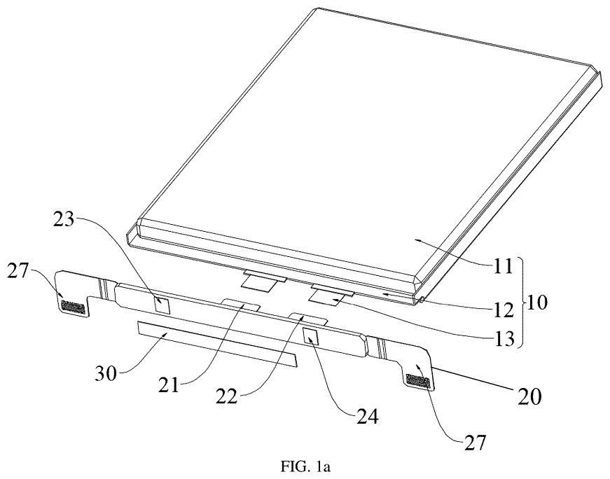

To solve the above problems, as shown in FIG. 1a, this embodiment provides a battery including a battery cell 10, a battery protective board 20, and a connecting member 30.

The battery cell 10 includes a battery cell body, a housing, and a tab 13. The housing includes a main body portion 11, a side edge banding, and a top edge banding 12. The battery cell body is encapsulated by the main body portion 11, both the side edge banding and the top edge banding 12 extend from the main body portion 11, the top edge banding 12 extends from a top surface of the main body portion 11, and the side edge banding extends from a side surface of the main body portion 11. Both two tabs 13 are connected to the battery cell body, and extend from the top edge banding 12 to an external of the housing. Both the two tabs 13 are disposed at an end of the battery cell 10, to facilitate connections of the two tabs 13. For ease of description, the two tabs 13 are respectively referred to as a first tab and a second tab with opposite polarities; and specific polarities of the first tab and the second tab are not limited in this embodiment, for example, the first tab is a positive tab, and the second tab is a negative tab; or the first tab is a negative tab, and the second tab is a positive tab.

The battery protective board 20 may be connected to the first tab and the second tab, and connected to an electronic component of an electronic device, to achieve the switching of the battery cell 10. The battery protective board 20 may play a role in protecting the battery cell 10. A conductive portion, a first circuit, and a second circuit are disposed on the battery protective board 20, the conductive portion may be disposed on a surface of the battery protective board 20, and the first circuit and the second circuit may be embedded in an interior of the battery protective board 20. The conductive portion includes a first conductive portion connected to the first tab and a second conductive portion connected to the second tab. The connecting member 30 includes a connecting end 31 and a connecting portion 32, a number of the connecting ends 31 is two, and the connecting portion 32 is connected to two connecting ends 31. A connecting end 31 of the two connecting ends 31 is connected to the first conductive portion, and another connecting end 31 of the two connecting ends 31 is connected to the second conductive portion. The second tab is connected to the first tab by sequentially passing through the second conductive portion, the connecting member, the first circuit, and the first conductive portion, to form a first connection circuit shown by connecting arrows in FIG. 1c, and the first tab is connected to the second tab by sequentially passing through the first conductive portion, the second circuit, and the second conductive portion, to form a second connection circuit shown by connecting arrows in FIG. 1b. Two current circuits in parallel may be formed by the first connection circuit and the second connection circuit, i.e., dual circuits in parallel are formed by the battery protective board 20 and the battery cell 10.

In this embodiment, the connecting member is disposed, and the conductive portion connected to the connecting member is disposed on the battery protective board, which reduces a number of tab welding, decreases difficulty in welding the tab and the battery protective board, and decreases difficulty in bending the battery protective board, compared to a battery cell with three tabs, thereby facilitating to reduce difficulty in installing the battery protective board. Furthermore, the conductive portion is connected to the tab, and the battery protective board is connected to the connecting member through the conductive portion, which may not only enhance welding reliability of a battery, but also enhance production efficiency. The second tab is connected to the first tab by sequentially passing through the second conductive portion, the connecting member, the first circuit, and the first conductive portion, to form the first connection circuit, and the first tab is connected to the second tab by sequentially passing through the first conductive portion, the second circuit, and the second conductive portion, to form the second connection circuit, and therefore, dual circuits in parallel are formed by the battery protective board and battery cell, which may not only reduce a magnitude of a current of a single circuit of the battery protective board, to enhance overcurrent capability of the battery protective board, but also reduce a dimension of the battery protective board, to increase an available dimension of a battery for accommodation, thus increasing capacity of a battery.

The first conductive portion includes a first conductive sheet 21 and a first conductive layer 23, the first conductive sheet 21 is electrically connected to the first conductive layer 23, and the first tab is electrically connected to the first conductive layer 23 through the first conductive sheet 21. The second conductive portion includes a second conductive sheet 22 and a second conductive layer 24, the second conductive sheet 22 is electrically connected to the second conductive layer 24, and the second tab is electrically connected to the second conductive layer 24 through the second conductive sheet 22.

In this embodiment, the first tab is electrically connected to the first conductive sheet 21, the first conductive sheet 21 is electrically connected to the first conductive layer 23, the second tab is electrically connected to the second conductive sheet 22, the second conductive sheet 22 is electrically connected to the second conductive layer 24, and the first conductive layer 23 and the second conductive layer 24 are electrically connected to the connecting member 30, respectively, so that the second tab is connected to the first tab by sequentially passing through the second conductive sheet 22, the second conductive layer 24, the connecting member 30, the first conductive layer 23, the first circuit, and the first conductive sheet 21, to form the first connection circuit (shown in FIG. 1c), and the first tab is connected to the second tab by sequentially passing through the second conductive sheet 22, the second circuit, and the first conductive sheet 21, to form the second connection circuit (shown in FIG. 1b). Two current circuits are formed, so that a current is shunted, thereby reducing a magnitude of a current of a single circuit of the battery protective board 20.

In this embodiment, the first conductive sheet 21 is electrically connected to the first conductive layer 23. For instance, a third circuit may be disposed in the battery protective board 20, and the first conductive sheet 21 may be connected to the first conductive layer 23 through the third circuit, to achieve an electrical connection between the first conductive sheet 21 and the first conductive layer 23. As an optional embodiment, the first conductive sheet 21 and the first conductive layer 23 are respectively located on both surfaces of the battery protective board 20, and the first conductive sheet 21 may be connected to the first conductive layer 23 through the third circuit.

The second conductive sheet 22 is electrically connected to the second conductive layer 24. For instance, a fourth circuit may be disposed in the battery protective board 20, and the second conductive sheet 22 may be connected to the second conductive layer 24 through the fourth circuit, to achieve an electrical connection between the second conductive sheet 22 and the second conductive layer 24. As an optional embodiment, the second conductive sheet 22 and the second conductive layer 24 are respectively located on both surfaces of the battery protective board 20, and the second conductive sheet 22 may be connected to the second conductive layer 24 through the fourth circuit.

It should be noted that the third circuit may be a part of the first circuit, and the fourth circuit may be a part of the second circuit.

In this embodiment, a pad or a nickel brick may be disposed on the first conductive layer 23 and the second conductive layer 24. For instance, the pad may be disposed on both the first conductive layer 23 and the second conductive layer 24; or the nickel brick may be disposed on both the first conductive layer 23 and the second conductive layer 24; or the pad may be disposed on the first conductive layer 23, while the nickel brick may be disposed on the second conductive layer 24. A connecting end 31 may be welded to the pad on the first conductive layer 23 by tin soldering, or a connecting end 31 may be welded to the nickel brick on the first conductive layer 23 by spot welding or laser welding; and another connecting end 31 may be welded to the pad on the first conductive layer 23 by tin soldering, or another connecting end 31 may be welded to the nickel brick on the first conductive layer 23 by spot welding or laser welding, thereby achieving electrical connections between the connecting ends 31 and the conductive layers, and further achieving an electrical connection between the connecting member 30 and the battery protective board 20.

In this embodiment, in addition to components that can conduct electricity disposed on the battery protective board 20, such as the conductive layers, the conductive sheets, or an electronic component, a circuit (such as the first circuit, the second circuit, the third circuit, or the fourth circuit) embedded in an interior of the battery protective board 20 may also be used to achieve electrical connections between some components on the battery protective board 20. The battery protective board 20 itself may be made of an insulating material, for example, a body of the battery protective board 20 may be made of a material such as plastic cement or flame-retardant resin.

As an optional embodiment, a thickness of the connecting member 30 ranges from 0.05 mm to 0.3 mm, and a width of the connecting member 30 ranges from 2 mm to 6 mm, which may not only enable the connecting member 30 to satisfy requirements of overcurrent capability, but also avoid affecting energy density of a battery due to a dimension of the connecting member 30 being too large.

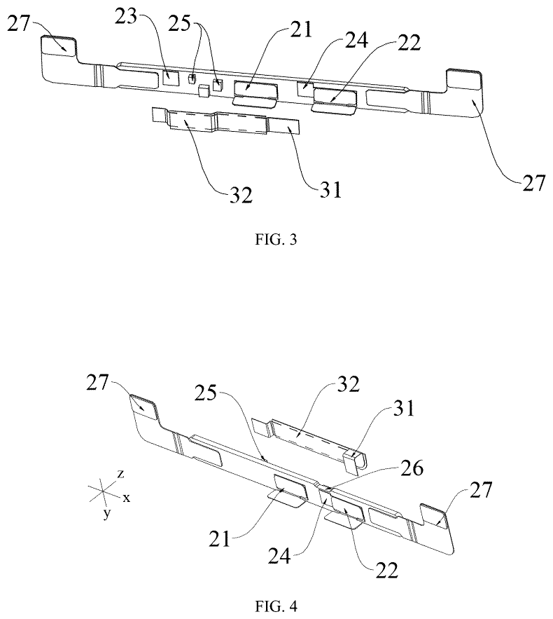

It should be noted that, in this embodiment, “thickness” refers to a dimension along a z-axis direction in FIG. 4, “width” refers to a dimension along an x-axis direction in FIG. 4, and “length” refers to a dimension along a y-axis direction in FIG. 4.

In this embodiment, the connecting member 30 may be a metal connecting member, for instance, a material of the connecting member 30 may be a metal such as nickel or copper, or may be an alloy material; and the connecting member 30 may also be a flexible connecting member, for instance, a material of the connecting member 30 may be a Flexible Printed Circuit (FPC). In this embodiment, the conductive sheet is made of a metal material, for instance, a material of the conductive sheet may be a metal such as nickel or copper, or may be an alloy material.

As an optional embodiment, the connecting member 30 may be straight sheet-shaped, and the connecting portion 32 and the two connecting ends 31 are in a same plane. The connecting portion 32 of the connecting member 30 may be tightly attached to the battery protective board 20, i.e., the connecting portion 32 may be in contact with the battery protective board 20, and the connecting portion 32 may also be bonded to the battery protective board 20 using double-sided tape, adhesive paper, or glue, to enhance stability of a connection between the connecting portion 32 and the battery protective board 20.

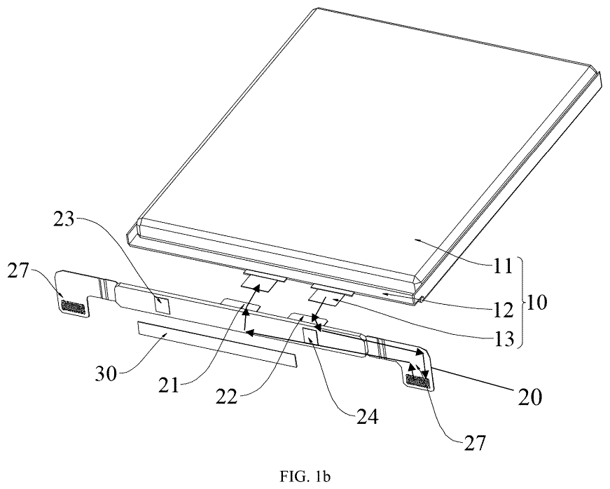

As shown in FIG. 2 to FIG. 4, an electronic component 25 is further disposed on the battery protective board 20, a number of the electronic components 25 may be set to multiple, and each electronic component 25 is disposed independently and insulated from each other. The electronic component 25 is electrically connected to at least one of the first circuit or the second circuit, i.e., the electronic component 25 may only be electrically connected to the first circuit; the electronic component 25 may also only be electrically connected to the second circuit; or a part of the electronic component 25 is electrically connected to the first circuit, and another part of the electronic component 25 is electrically connected to the second circuit. The circuit to which the electronic component 25 is connected may be set by the technical personnel in the field according to actual situations.

As an optional embodiment, the electronic component 25 is disposed between the first conductive layer 23 and the second conductive layer 24, the electronic component 25 is located between the battery protective board 20 and the connecting portion 32 of the connecting member 32, and an insulating layer is disposed between the connecting portion 32 and the electronic component 25, to avoid short circuits caused by contact between the connecting portion 32 and the electronic component 25. The insulating layer may be covered on a surface, close to the electronic component 25, of the connecting portion 32, or covered on at least a part of a surface of the connecting portion 32, or covered on a surface of the electronic component 25. As an optional embodiment, the insulating layer may be made of insulating adhesive or insulating paper. It should note that the connecting end 31 in this embodiment may not be covered with an insulating layer, to avoid affecting the welding of the connecting end 31.

As an optional embodiment, along a thickness direction of the battery protective board 20 (i.e., along the z-axis in FIG. 4), at least a part of the connecting portion 32 protrudes from a plane where the two connecting ends 31 are located, to form an avoidance space between the connecting portion 32 and the battery protective board 20, and the electronic component 25 is accommodated in the avoidance space, to avoid interference between the electronic component 25 and the connecting portion 32 and avoid a risk of short circuits caused by contact between the electronic component 25 and the connecting portion 32. Under the circumstances, a distance between a protruding part of the connecting portion 32 and the battery protective board 20 is greater than a thickness by which the electronic component 25 protrudes from a plane where the battery protective board 20 is located. As an optional embodiment, in a case that T1 represents a thickness of the electronic component 25 along the z-axis direction in FIG. 4, (i.e., the thickness by which the electronic component 25 protrudes from the plane where the battery protective board 20 is located), T2 represents a thickness of the connecting portion 32 along the z-axis direction in FIG. 4, and H represents the distance between the protruding part of the connecting portion 32 and the battery protective board 20 along the z-axis direction in FIG. 4, the following relationship is satisfied: T1+T2+0.5 mm≥H>T1, which may not only avoid a risk of short circuits caused by contact between the electronic component 25 and the connecting portion 32, but also avoid affecting energy density of a battery due to a dimension of the connecting member 30 being too large.

In this embodiment, the battery protective board 20 includes a first side surface and a second side surface disposed opposite to each other along the thickness direction of the battery protective board 20 (i.e., along the z-axis direction in FIG. 4), both the first conductive sheet 21 and the second conductive sheet 22 are disposed on the first side surface, and the electronic component 25 is disposed on one of the first side surface or the second side surface. I.e., the first conductive sheet 21 and the second conductive sheet 22 are disposed at a same side of the battery protective board 20 along the thickness direction of the battery protective board 20 (i.e., along the z-axis direction in FIG. 4), to facilitate a connection between the tab 13 and at least one of the first conductive sheet 21 or the second conductive sheet 22. However, the electronic component 25 may be disposed on different surfaces of the battery protective board 20 based on different situations.

As an optional embodiment, for instance, as shown in FIG. 2, the electronic component 25, the connecting member 30, the first conductive layer 23, and the second conductive layer 24 are all disposed on the second side surface, while both the first conductive sheet 21 and the second conductive sheet 22 are disposed on the first side surface, thereby avoiding short circuits caused by contact between the connecting member 30 and one of the tab 13 or the battery cell 10. Under the circumstances, the second conductive layer 24 and the second conductive sheet 22 are respectively disposed on both sides of the battery protective board 20 along the thickness direction of the battery protective board 20 (i.e., along the z-axis direction in FIG. 4), the second conductive layer 24 and the second conductive sheet 22 are disposed opposite to each other in position, and the second conductive layer 24 is electrically connected to the second conductive sheet 22. Distances between the connecting portion 32 in various positions and the battery protective board 20 are equal. As an optional embodiment, a fourth circuit may be disposed in the battery protective board 20, and the second conductive sheet 22 may be connected to the second conductive layer 24 through the fourth circuit, to achieve an electrical connection between the second conductive layer 24 and the second conductive sheet 22; or a via hole may also be disposed on the battery protective board 20, and the second conductive sheet 22 is electrically connected to the second conductive layer 24 through the via hole.

The battery protective board 20 shown in FIG. 2 is such a battery protective board 20 which is insufficient to dispose the conductive portion and the electronic component 25 due to its first side surface (i.e., a surface where the conductive sheet is disposed) having a relatively small space. Additionally, the battery protective board 20 shown in FIG. 2 is not suitable for batteries with stringent thickness requirements at a top of a battery.

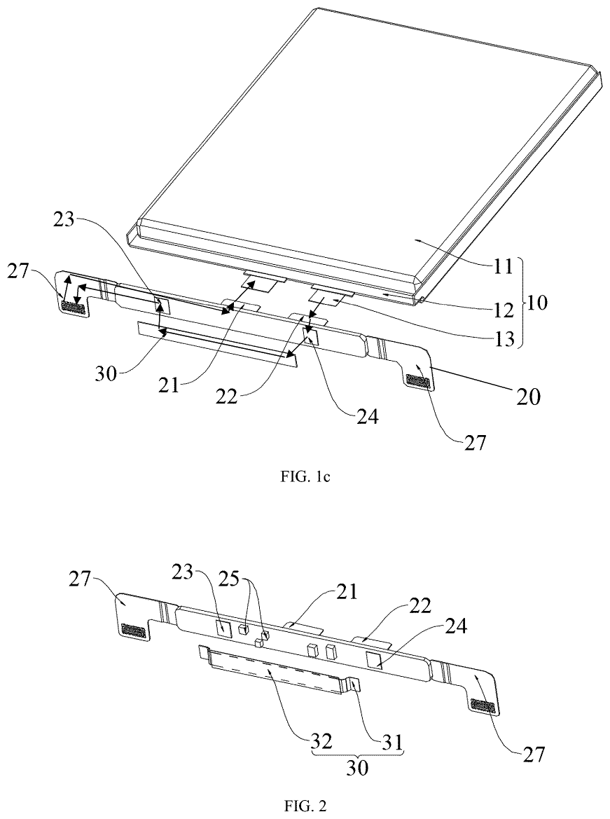

As an optional embodiment, as shown in FIG. 3, the electronic component 25, the connecting member 30, the first conductive layer 23, the second conductive layer 24, the first conductive sheet 21, and the second conductive sheet 22 are all disposed on the first side surface. Therefore, the connecting member 30 and the two conductive sheets are disposed on a same side surface of the battery protective board 20, to avoid an increase in an overall thickness at a head of a battery, thereby facilitating to reduce a volume of a space occupied by the battery protective board 20, and further enhancing capacity of a battery. Under the circumstances, the second conductive layer 24 and the second conductive sheet 22 are disposed at a same side of the battery protective board 20 along the thickness direction of the battery protective board 20 (i.e., along the z-axis direction in FIG. 4), and the second conductive layer 24 may be connected to the second conductive sheet 22 by welding or hot melting. As an optional embodiment, a connection between the second conductive layer 24 and the second conductive sheet 22 may be a splitting connection or an integrated connection. Furthermore, the first conductive sheet 21 is disposed between the first conductive layer 23 and the second conductive layer 24, and the electronic component 25 is disposed between the first conductive layer 23 and the first conductive sheet 21, thereby making layout of each assembly relatively reasonable and compact.

As an optional embodiment, the connecting portion 32 protrudes from a plane where the two connecting ends 31 are located, and the connecting portion 32 may protrude in a step shape. For instance, the connecting portion 32 includes a first connecting portion and a second connecting portion connected to each other, and a step-shaped connecting portion 32 is formed by the first connecting portion and the second connecting portion. The first connecting portion is located in a region where the connecting portion 32 and the electronic component 25 are disposed opposite to each other, i.e., the electronic component 25 is located between the battery protective board 20 and the first connecting portion. The second connecting portion is located in a region where the connecting portion 32 and the first conductive sheet 21 are disposed opposite to each other, i.e., the first conductive sheet 21 is located between the battery protective board 20 and the second connecting portion. A thickness of the first connecting portion protruding from the plane where the two connecting ends 31 are located is greater than a thickness of the second connecting portion protruding from the plane where the two connecting ends 31, so that a distance between the first connecting portion and the battery protective board 20 is greater than a distance between the second connecting portion and the battery protective board 20. Consequently, avoidance spaces with different sizes are formed between the connecting portion 32 and the battery protective board 20, and between the connecting portion 32 and the first conductive sheet 21, which not only facilitates to reduce a volume of a space occupied by the battery protective board 20, but also avoids a risk of short circuits caused by contact between the electronic component 25 and the connecting portion 32, and between the first conductive sheet 21 and the connecting portion 32.

In this embodiment, to further avoid the risk of the short circuits caused by contact between the electronic component 25 and the connecting portion 32, and between the first conductive sheet 21 and the connecting portion 32, an insulating layer may also be covered on surfaces, close to the electronic component 25 and close to the first conductive sheet 21, of the connecting portion 32, and an insulating layer may also be covered on at least a part of a surface of the connecting portion 32 or at least a part of a surface of the electronic component 25.

The battery protective board 20 shown in FIG. 3 is such a battery protective board 20 which is sufficient to dispose the conductive portion and the electronic component 25 due to its first side surface (i.e., a surface where the conductive sheet is disposed) having a relatively large space. Additionally, the battery protective board 20 shown in FIG. 3 is suitable for batteries with stringent thickness requirements at a top of a battery.

As an optional embodiment, as shown in FIG. 4, the electronic component 25, the connecting member 30, and the first conductive layer 23 are all disposed on the second side surface, while the first conductive sheet 21, the second conductive sheet 22, and the second conductive layer 24 are all disposed on the first side surface, thereby avoiding short circuits caused by contact between the connecting member 30 and one of the tab 13 or the battery cell 10. Under the circumstances, the second conductive layer 24 and the second conductive sheet 22 are located at a same side of the battery protective board 20 along the thickness direction of the battery protective board 20 (i.e., along the z-axis direction in FIG. 4), and the second conductive layer 24 may be connected to the second conductive sheet 22 by welding or hot melting, and distances between the connecting portion 32 in various positions and the battery protective board 20 are equal. Furthermore, to facilitate a connection between the connecting end 31 of the connecting member 30 and the second conductive layer 24, a connecting end 31 of the connecting member 30 may be bent from the second side surface to the first side surface, to facilitate the connection between the connecting end 31 and the second conductive layer 24.

Certainly, in the embodiment, the first conductive layer 23 may also be disposed on the first side surface, and the second conductive layer 24 may also be disposed on the second side surface. The first conductive layer 23 and the first conductive sheet 21 are located at a same side of the battery protective board 20 along the thickness direction of the battery protective board 20 (i.e., along the z-axis direction in FIG. 4), the first conductive layer 23 is connected to the first conductive sheet 21 by welding or hot melting, and a connecting end 31 of the connecting member 30 may be bent from the second side surface to the first side surface, to facilitate a connection between the connecting end 31 and the first conductive layer 23.

In this embodiment, both the first conductive layer 23 and the second conductive layer 24 may also be disposed on the first side surface, and the first conductive layer 23, the first conductive sheet 21, the second conductive layer 24, and the second conductive sheet 22 are all located at a same side of the battery protective board 20 along the thickness direction of the battery protective board 20 (i.e., along the z-axis direction in FIG. 4). The first conductive layer 23 is electrically connected to the first conductive sheet 21, the second conductive layer 24 is electrically connected to the second conductive sheet 22, and both the two connecting ends 31 of the connecting member 30 are bent from the second side surface to the first side surface, so that the two connecting ends 31 are connected to the first conductive layer 23 and the second conductive layer 24 by welding, respectively.

On the basis of the aforementioned embodiments, a first notch 26 is formed at an edge of the battery protective board 20, and the connecting end 31 at a bend may be accommodated within the first notch 26. A number of the first notches 26 is one or two, the number of the first notches 26 is determined based on a number of the connecting ends 31 bent from the second side surface to the first side surface. Thus, the first notch 26 on the battery protective board 20 may be used to provide a bending space for the connecting end 31, thereby avoiding an increase in a volume of a space occupied by the battery protective board 20 when the connecting end 31 is bent from the second side surface to the first side surface.

In this embodiment, along the x-axis direction in FIG. 4, a width of the first notch 26 is greater than a width of the connecting end 31 at a bend. Along the y-axis direction in FIG. 4, a depth of the first notch 26 is greater than or equal to a thickness of the connecting end 31 at a bend. The depth of the first notch 26 refers to a dimension of the first notch 26 along a length direction of the battery protective board 20 (i.e., along the y-axis direction in FIG. 4). As an optional embodiment, the width of the first notch 26 is L1, the depth of the first notch 26 is W, the width of the connecting end 31 at a bend is L2, and the thickness of the connecting end 31 at a bend is T, which satisfies L1≥L2+0.5 mm, and W≥T, so that the connecting end 31 at a bend may be accommodated within the first notch 26, to meet dimensional deviation of the connecting end 31 at a bend and prevent the connecting end 31 from protruding from an edge of the battery protective board 20.

The battery protective board 20 in FIG. 4 is such a battery protective board 20 which is insufficient to dispose two conductive portions due to its first side surface (i.e., a surface where the conductive sheet is disposed) having a relatively small space. Furthermore, along the y-axis direction in FIG. 4, a length of the battery protective board 20 in FIG. 4 is relatively large, so that the first notch 26 may be disposed at the edge of the battery protective board 20.

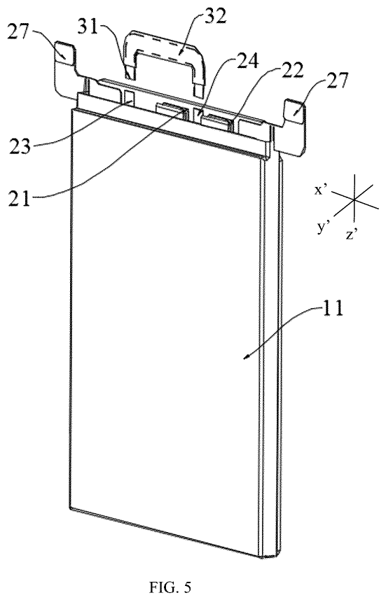

In this embodiment, the connecting member 30 may adopt a rectangular sheet structure shown in FIG. 1a; the connecting member 30 may also adopt a protrusion sheet structure shown in FIG. 2 and FIG. 4; the connecting member 30 may also adopt a step protrusion sheet structure shown in FIG. 3; and the connecting member 30 may also adopt a U-shaped sheet structure shown in FIG. 5 to FIG. 7. The rectangular sheet structure means that the two connecting end 31 and the connecting portion 32 are in a same plane. The protrusion sheet structure means that a plane where the two connecting ends 31 are located is parallel to a plane where the connecting portion 32 is located, but the connecting portion 32 protrudes from the plane where the connecting ends 31 are located. The step protrusion sheet structure means that a plane where the two connecting ends 31 are located is parallel to a plane where the connecting portion 32 is located, but the connecting portion 32 protrudes from the plane where the connecting ends 31 are located, and the connecting portion 32 is step-shaped. The U-shaped sheet structure means that the two connecting ends 31 and the connecting portion 32 are U-shaped together. In a case that a structure of the connecting member 30 is shown in FIG. 1a to FIG. 4, a projection of the connecting member 30 along the thickness direction of the battery protective board 20 (i.e., along the z-axis direction in FIG. 4) is located within the battery protective board 20, thereby avoiding affecting a volume of a space occupied by the battery protective board 20 due to a dimension of the connecting member 30 being too large.

As an optional embodiment, as shown in FIG. 5, the first conductive layer 23, the second conductive layer 24, the first conductive sheet 21, and the second conductive sheet 22 are all disposed at a same side of the battery protective board 20 along the thickness direction of the battery protective board 20 (i.e., along a y′-axis direction in FIG. 5), and the electronic component 25 (not shown in FIG. 5), the first conductive sheet 21, and the second conductive sheet 22 may also be disposed at a same side of the battery protective board 20 along the thickness direction of the battery protective board 20 (i.e., along the y′-axis direction in FIG. 5). The connecting member 30 is a U-shaped connecting member, and the U-shaped connecting member 30 extends toward a direction away from the top edge banding 12. Thus, after the two conductive sheets are welded to the tabs, bending the connecting member 30 can avoid occupying a space of the battery along a z′-axis direction in FIG. 5.

When the U-shaped connecting member 30 is used, the connecting member 30 is a flexible connecting member, a part of the connecting member 30 is bent, and the connecting member 30 is connected to the battery cell 10. A material used for manufacturing the connecting member 30 is a flexible material, to facilitate bending. As an optional embodiment, a bending part may be the connecting portion 32, the connecting portion 32 is bent, and the connecting member 30 is connected to the battery cell 10, to fix the connecting member 30.

During a battery fabrication, encapsulation processes are typically used in the formation of a deep pit surface (i.e., a first pit) and a shallow pit surface (i.e., a second pit) on the top edge banding 12 of the battery cell 10, and the deep pit surface and the shallow pit surface are located on two opposing sides of the top edge banding 12 along a thickness direction of the battery cell 10 (i.e., the y′-axis direction in FIG. 5).

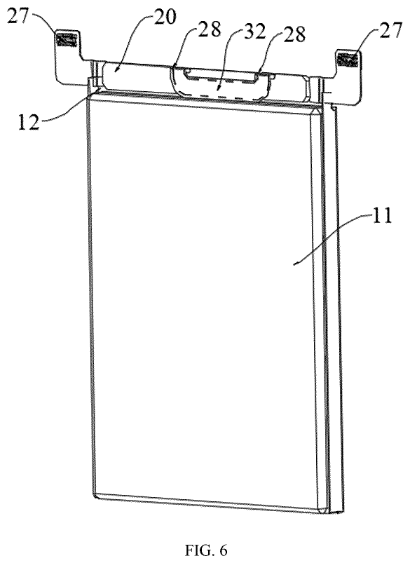

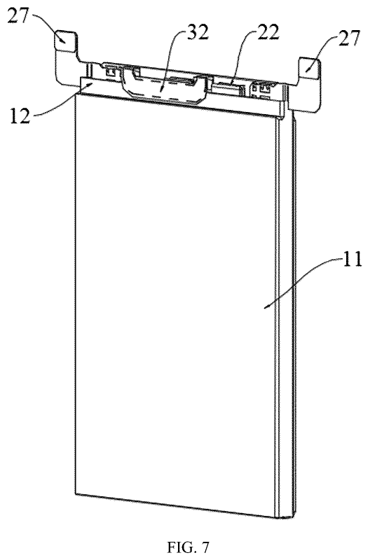

As shown in FIG. 6 and FIG. 7, the U-shaped connecting member 30 extends toward a direction close to the top edge banding 12, for instance, at least a part of the connecting portion 32 enters the deep pit surface, or at least a part of the connecting portion 32 enters the shallow pit surface, which on the one hand can avoid affecting a volume of a space occupied by the battery protective board 20 due to a dimension of the connecting member 30 being too large, and on the other hand can facilitate a connection between the connecting member 30 and the battery cell 10, to achieve a fixation of the connection member 30, and enhance stability of the connection between the connecting member 30 and the battery cell 10.

As shown in FIG. 6, a second notch 28 may also be disposed at an edge of the battery protective board 20, the connecting portion 32 at a bend is accommodated within the second notch 28, so that the second notch 28 on the battery protective board 20 may be used to provide a bending space for the connecting portion 32, to avoid an increase in a volume of a space occupied by the battery protective board 20 when the connecting portion 32 is bent. As an optional embodiment, two second notches 28 are disposed on the battery protective board 20, and the two second notches 28 are arranged along a width direction of the battery (i.e., an x′-axis direction in FIG. 5). Both the first conductive layer 23 and the second conductive layer 24 are disposed on a surface, close to the shallow pit surface, of the battery protective board 20, the connecting member 30 is bent to enter the deep pit surface, and at this time, the connecting portion 32 at bends are accommodated within the second notches 28, respectively, so that the two connecting ends 31 connected to the connecting portion 32 can be connected to the first conductive layer 23 and the second conductive layer 24, respectively.

In this embodiment, along the x′-axis direction in FIG. 5, a width of the second notch 28 is greater than a width of the connecting portion 32 at a bend. Along the z′-axis direction in FIG. 5, a depth of the second notch 28 is greater than or equal to a thickness of the connecting portion 32 at a bend. The depth of the second notch 28 refers to a dimension of the second notch 28 along the z′-axis direction in FIG. 5. As an optional embodiment, the width of the second notch 28 is L3, the depth of the second notch 28 is W1, the width of the connecting portion 32 at a bend is L4, and the thickness of the connecting portion 32 at a bend is T1, which satisfies L3≥L4+0.5 mm, and W1≥T1, so that the connecting portion 32 at a bend may be accommodated within the second notch 28, to meet dimensional deviation of the connecting portion 32 at a bend and prevent the connecting portion 32 from protruding from an edge of the battery protective board 20.

The battery protective board 20 shown in FIG. 5 to FIG. 7 is suitable for batteries with stringent thickness requirements at a top of a battery, and the pit surface may be used to reduce a thickness at a top of a battery.

In this embodiment, the connecting portion 32 is fixedly connected to the top edge banding 12 of the battery cell 10 by double-sided tape, adhesive paper, or glue. For instance, the connecting portion 32 may be fixedly connected to the top edge banding 12 of the battery cell 10 by the double-sided tape, may also be fixedly connected to the top edge banding 12 of the battery cell 10 by the adhesive paper, and may also be fixedly connected to the top edge banding 12 of the battery cell 10 by the glue, to achieve a connection between the connecting portion 32 and the battery cell 10, thus achieving fixation of the connecting member 30 and enhancing stability of the connection between the connecting member 30 and the battery cell 10.

In this embodiment, the double-sided tape, the adhesive paper, or the glue may be set as an insulating type, or an insulating layer may also be covered on the connecting portion 32, to avoid short circuits caused by a direct connection between the connecting portion 32 and one of the tab 13, the battery cell 10, or the electronic component 25 while achieving fixation of the connecting member 30.

As shown in FIG. 1a to FIG. 7, a connector 27 is further disposed on the battery protective board 20 in this embodiment, at least two connectors 27 are disposed, and the at least two connectors 27 are disposed at both ends of the battery protective board 20, respectively. The connector 27 is used to electrically connect to an external device to be powered. As an optional embodiment, the battery protective board 20 is provided with two connectors 27, and the two connectors 27 are disposed at both ends of the battery protective board 20, respectively. As shown in FIG. 1b and FIG. 1c, the two connectors 27 may be connected to the first connection circuit and the second connection circuit, respectively, so that a current in the battery cell 10 is electrically conducted to the external device to be powered through the first connection circuit and the second connection circuit.

This embodiment further provides an electronic device including the battery in any one of the aforementioned embodiments.

The electronic device in the present application is not specifically limited, which may be any known electronic device in related technologies. In some alternative embodiments, the electronic device may be a mobile phone, a laptop or a tablet, as well as a wearable device, a gaming console, or the like.

While the present application is presented above, the scope of protection of the present application is not limited thereto. Those skilled in the art may make various changes and modifications without departing from the spirit and scope of the present application, all of which fall within the scope of protection of the present application.

What is claimed is:

1. A battery, comprising: a battery cell, a battery protective board, and a connecting member,
wherein the battery cell comprises a first tab and a second tab with opposite polarities; and
the battery protective board is provided with a conductive portion, a first circuit, and a second circuit, the conductive portion comprises a first conductive portion and a second conductive portion, the first conductive portion is connected to the first tab, and the second conductive portion is connected to the second tab; an end of the connecting member is connected to the first conductive portion, and another end of the connecting member is connected to the second conductive portion; the second tab is connected to the first tab by sequentially passing through the second conductive portion, the connecting member, the first circuit, and the first conductive portion, to form a first connection circuit; and the first tab is connected to the second tab by sequentially passing through the first conductive portion, the second circuit, and the second conductive portion, to form a second connection circuit.

2. The battery according to claim 1, wherein the first conductive portion comprises a first conductive sheet and a first conductive layer, the first conductive sheet is electrically connected to the first conductive layer, and the first tab is electrically connected to the first conductive layer through the first conductive sheet; and
the second conductive portion comprises a second conductive sheet and a second conductive layer, the second conductive sheet is electrically connected to the second conductive layer, and the second tab is electrically connected to the second conductive layer through the second conductive sheet.

3. The battery according to claim 2, wherein the battery protective board is further provided with a third circuit, and the first conductive sheet is connected to the first conductive layer through the third circuit; and/or
the battery protective board is further provided with a fourth circuit, and the second conductive sheet is connected to the second conductive layer through the fourth circuit.

4. The battery according to claim 2, wherein the second tab is connected to the first tab by sequentially passing through the second conductive sheet, the second conductive layer, the connecting member, the first conductive layer, the first circuit, and the first conductive sheet, to form the first connection circuit; and
the first tab is connected to the second tab by sequentially passing through the first conductive sheet, the second circuit, and the second conductive sheet, to form the second connection circuit.

5. The battery according to claim 2, wherein the connecting member comprises a first connecting end, a second connecting end, and a connecting portion, the first connecting end is connected to the second connecting end through the connecting portion, the first conductive layer is connected to the first connecting end by welding, and the second conductive layer is connected to the second connecting end by welding.

6. The battery according to claim 5, wherein the battery protective board is further provided with an electronic component, the electronic component is connected to at least one of the first circuit or the second circuit, the electronic component is disposed between the first conductive layer and the second conductive layer, the electronic component is located between the battery protective board and the connecting portion, and an insulating layer is disposed between the connecting portion and the electronic component.

7. The battery according to claim 6, wherein along a thickness direction of the battery protective board, at least a part of the connecting portion protrudes from a plane where the first connecting end and the second connecting end are located, and a distance between a protruding part of the connecting portion and the battery protective board is greater than a thickness by which the electronic component protrudes from a plane where the battery protective board is located.

8. The battery according to claim 6, wherein the connecting portion comprises a first connecting portion and a second connecting portion, a step-shaped connecting portion is formed by the first connecting portion and the second connecting portion, the electronic component is located between the battery protective board and the first connecting portion, the first conductive sheet is located between the battery protective board and the second connecting portion, and along a thickness direction of the battery protective board, a distance between the first connecting portion and the battery protective board is greater than a distance between the second connecting portion and the battery protective board.

9. The battery according to claim 6, wherein the battery protective board comprises a first side surface and a second side surface disposed opposite to each other along a thickness direction of the battery protective board, both the first conductive sheet and the second conductive sheet are disposed on the first side surface, and the electronic component is disposed on either of the following surfaces: the first side surface or the second side surface.

10. The battery according to claim 9, wherein the connecting member, the electronic component, and the second conductive layer are all disposed on the second side surface, the second conductive sheet is disposed on the first side surface, the second conductive layer and the second conductive sheet are disposed opposite to each other, and along the thickness direction of the battery protective board, distances between the connecting portion in various positions and the battery protective board are equal.

11. The battery according to claim 9, wherein the electronic component, the second conductive layer, the second conductive sheet, the first conductive layer, and the first conductive sheet are all disposed on the first side surface, the second conductive layer is connected to the second conductive sheet, the first conductive sheet is disposed between the first conductive layer and the second conductive layer, and the electronic component is disposed between the first conductive layer and the first conductive sheet.

12. The battery according to claim 9, wherein the electronic component and the connecting member are disposed on the second side surface, and along the thickness direction of the battery protective board, distances between the connecting portion in various positions and the battery protective board are equal;
the second conductive portion is disposed on the first side surface, the second conductive layer is connected to the second conductive sheet, and the second connecting end is bent from the second side surface to the first side surface and is electrically connected to the second conductive layer; and
the first conductive portion is disposed on the first side surface, the first conductive layer is connected to the first conductive sheet, and the first connecting end is bent from the second side surface to the first side surface and is electrically connected to the first conductive layer.

13. The battery according to claim 12, wherein two first notches are formed at an edge of the battery protective board; in a case that the second connecting end is bent from the second side surface to the first side surface, the second connecting end at a bend is accommodated within an first notch of the two first notches; and in a case that the first connecting end is bent from the second side surface to the first side surface, the first connecting end at a bend is accommodated within another first notch of the two first notches.

14. The battery according to claim 5, wherein a U-shaped connecting member is formed by the first connecting end, the second connecting end, and the connecting portion, and the U-shaped connecting member is a flexible connecting member.

15. The battery according to claim 14, wherein the battery cell further comprises a top edge banding, the first tab and the second tab extend from the top edge banding, and the U-shaped connecting member extends toward a direction away from the top edge banding.

16. The battery according to claim 14, wherein the battery cell further comprises a top edge banding, the first tab and the second tab extend from the top edge banding, the U-shaped connecting member extends toward a direction close to the top edge banding, two second notches are formed at an edge of the battery protective board, and the connecting portion at bends are respectively accommodated within the two second notches.

17. The battery according to claim 16, wherein the connecting portion is fixedly connected to the top edge banding by double-sided tape, adhesive paper, or glue.

18. The battery according to claim 1, wherein the battery protective board is further provided with at least two connectors, and in a case that the at least two connectors comprise two connectors, along a width direction of the battery cell, both the two connectors are respectively disposed at both ends of the battery protective board, and the two connectors are electrically connected to the first connection circuit and the second connection circuit, respectively.

19. An electronic device, comprising a battery, wherein the battery comprises: a battery cell, a battery protective board, and a connecting member;
the battery cell comprises a first tab and a second tab with opposite polarities; and
the battery protective board is provided with a conductive portion, a first circuit, and a second circuit, the conductive portion comprises a first conductive portion and a second conductive portion, the first conductive portion is connected to the first tab, and the second conductive portion is connected to the second tab; an end of the connecting member is connected to the first conductive portion, and another end of the connecting member is connected to the second conductive portion; the second tab is connected to the first tab by sequentially passing through the second conductive portion, the connecting member, the first circuit, and the first conductive portion, to form a first connection circuit; and the first tab is connected to the second tab by sequentially passing through the first conductive portion, the second circuit, and the second conductive portion, to form a second connection circuit.
